(19) United States
(12) Patent Application Publication
(10) Pub. No.: US 2023/0281448 A1
(43) Pub. Date: Sep. 7, 2023

(54) METHOD AND APPARATUS FOR INFORMATION RECOMMENDATION, ELECTRONIC DEVICE, COMPUTER READABLE STORAGE MEDIUM AND COMPUTER PROGRAM PRODUCT

(71) Applicant: Tencent Technology (Shenzhen) Company Limited, Shenzhen (CN)

(72) Inventors: Li MA, Shenzhen (CN); Zhong ZHAO, Shenzhen (CN); Hanming LIANG, Shenzhen (CN); Guangyao ZHAO, Shenzhen (CN); Yanmei FU, Shenzhen (CN); Weibo HU, Shenzhen (CN); Xinsheng HE, Shenzhen (CN); Mingjin WU, Shenzhen (CN)

(21) Appl. No.: 18/196,373

(22) Filed: May 11, 2023

Related U.S. Application Data
(63) Continuation of application No. PCT/CN2022/116402, filed on Sep. 1, 2022.

(30) Foreign Application Priority Data
Oct. 12, 2021 (CN) 202111184748.8

(51) Int. Cl. G06N 3/08

(52) U.S. Cl. CPC G06N 3/08

(57) ABSTRACT

This application provides a method for information recommendation performed by an electronic device. The method includes: encoding a plurality of reference features to obtain an encoding feature of each reference feature; performing first mapping processing on the plurality of encoding features to obtain a plurality of first recommendation scores in one-to-one correspondence with a plurality of recommendation dimensions; performing second mapping processing on the plurality of encoding features to obtain a mapping feature; performing fusion processing on the first recommendation scores of the plurality of recommendation dimensions based on the mapping feature to obtain a fusion feature, and performing recommendation score prediction processing on the to-be-recommended information based on the fusion feature to obtain a second recommendation score of the target object for the to-be-recommended information; and executing a recommendation operation of the to-be-recommended information corresponding to the target object based on the second recommendation score.

### CROSS-REFERENCE TO RELATED APPLICATIONS

This application is a continuation application of PCT Patent Application No. PCT/CN2022/116402, entitled “METHOD AND APPARATUS FOR INFORMATION RECOMMENDATION, ELECTRONIC DEVICE, COMPUTER READABLE STORAGE MEDIUM AND COMPUTER PROGRAM PRODUCT” filed on Sep. 1, 2022, which claims priority to the Chinese Patent Application No. 202111184748.8, entitled “METHOD AND APPARATUS FOR INFORMATION RECOMMENDATION, ELECTRONIC DEVICE, COMPUTER READABLE STORAGE MEDIUM AND COMPUTER PROGRAM PRODUCT” filed on Oct. 12, 2021, all of which is incorporated herein by reference in its entirety.

### FIELD OF THE TECHNOLOGY

This application relates to the field of Internet of vehicles and an artificial intelligence technology, in particular to a method and apparatus for information recommendation, an electronic device, a computer readable storage medium and a computer program product.

### BACKGROUND OF THE DISCLOSURE

Artificial intelligence (AI) is a theory, a method, a technology, and an application system that use a digital computer or a machine controlled by the digital computer to simulate, extend, and expand human intelligence, perceive an environment, and obtain and use knowledge so as to obtain an optimal result.

An artificial intelligence technology is widely applied to a recommendation system, for example, information of interest to users is recommended to an appropriate user through a multi-recommendation-target ranking model of the recommendation system, the multi-recommendation-target ranking model estimates a score of information from recommendation dimensions (also called targets) such as click of the information, a consumption duration and interactive behaviors of a user, and after a score for each target is obtained, how to fuse a plurality of scores will affect accuracy and user experience of the recommendation system.

A fusion solution in the related art cannot accurately predict scores different users for information and thus cannot be suitable for personalized recommendation, so recommendation accuracy of the recommendation system is difficult to increase.

### SUMMARY

Embodiments of this application provide a method and apparatus for information recommendation, an electronic device, a computer readable storage medium and a computer program product, which can accurately predict a recommendation score of a user for to-be-recommended information so as to increase recommendation accuracy of a recommendation system.

Technical solutions in the embodiments of this application are implemented as follows.

An embodiment of this application provides a method for information recommendation performed by an electronic device, including:
performing encoding processing on a plurality of reference features to obtain an encoding feature of each reference feature;
performing first mapping processing on the plurality of encoding features to obtain a plurality of first recommendation scores in one-to-one correspondence with a plurality of recommendation dimensions, the first recommendation scores representing recommendation scores of a target object for to-be-recommended information in the corresponding recommendation dimensions;
performing second mapping processing on the plurality of encoding features in each of the plurality of recommendation dimensions to obtain a mapping feature of the recommendation dimension;
performing fusion processing on the first recommendation scores of the plurality of recommendation dimensions based on the mapping feature of each of the plurality of recommendation dimensions to obtain a fusion feature of the recommendation dimension, and performing recommendation score prediction processing on the to-be-recommended information based on the fusion feature to obtain a second recommendation score of the target object for the to-be-recommended information; and
executing a recommendation operation of the to-be-recommended information corresponding to the target object based on the second recommendation score.

An embodiment of this application provides an electronic device, including:
a memory, configured to store a computer executable instruction; and
a processor, configured to implement, when executing the computer executable instruction stored in the memory, a method for information recommendation provided by an embodiment of this application.

An embodiment of this application provides a non-transitory computer readable storage medium, storing a computer executable instruction that, when executed by a processor of an electronic device, causes the electronic device to perform a method for information recommendation provided by an embodiment of this application.

The embodiments of this application have the following beneficial effects:
the first recommendation scores of the target object for the to-be-recommended information in the plurality of recommendation dimensions (such as click, a duration and interaction) are predicted through the encoding features of the plurality of reference features of the target object, the encoding features are mapped in all the recommendation dimensions in a mode of feature mapping to obtain the mapping features representing the first recommendation scores in the corresponding recommendation dimensions, fusion processing is performed on the first recommendation scores of all the recommendation dimensions based on the mapping features, and the final second recommendation score of the target object for the to-be-recommended information is predicted based on a fusion result; and therefore, fusion of scores of all the recommendation dimensions may be performed by using fusion modes suitable for corresponding target objects according to the reference features of the different target objects, a purpose of obtaining a final accurate recommendation score automatically according to inclination of the target objects in the different recommendation dimensions is achieved, prediction accuracy of the final recommendation score can be improved, accurate recommendation reference data are provided for the recommendation system, and thus the recommendation accuracy and user experience are improved.

### BRIEF DESCRIPTION OF THE DRAWINGS

FIG. 1 is a schematic architectural diagram of an information recommendation system 10 provided by an embodiment of this application.

FIG. 2 is a schematic structural diagram of an electronic device 500 for information recommendation provided by an embodiment of this application.

FIG. 3A is a schematic flowchart of a method for information recommendation provided by an embodiment of this application.

FIG. 3B is a schematic diagram of determining of a first recommendation score provided by an embodiment of this application.

FIG. 3C is a schematic diagram of determining of a fitting feature provided by an embodiment of this application.

FIG. 4 is a fourth schematic diagram of information recommendation provided by an embodiment of this application.

FIG. 5A is a schematic flowchart of a model training method provided by an embodiment of this application.

FIG. 5B is a schematic flowchart of a model parameter updating method provided by an embodiment of this application.

FIG. 6 is a fifth schematic diagram of information recommendation provided by an embodiment of this application.

FIG. 7A is a first schematic diagram of an information recommendation effect provided by an embodiment of this application.

FIG. 7B is a second schematic diagram of an information recommendation effect provided by an embodiment of this application.

FIG. 7C is a third schematic diagram of an information recommendation effect provided by an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts fall within the protection scope of this application.

In the following description, “some embodiments” describes subsets of all possible embodiments, but it may be understood that “some embodiments” may be the same subset or different subsets of all the possible embodiments, and may be combined with each other without conflict.

In the following description, the involved terms “first\second\third” are merely intended to distinguish similar objects rather than represent a specific order for objects. It may be understood that “first\second\third” may be interchangeable in a specific sequence or a precedence order with permission so that the embodiments of this application described herein may be implemented in a sequence other than that illustrated or described here.

Unless otherwise defined, meanings of all technical and scientific terms used herein are the same as those usually understood by a person of skill in the art to which this application belongs. Terms used herein are merely intended to describe the embodiments of this application, but are not intended to limit this application.

Before the embodiments of this application are further described in detail, description is made on nouns and terms involved in the embodiments of this application, and the nouns and terms involved in the embodiments of this application are applicable to the following explanations.
1) Click through rate (CTR): referring to a ratio of the number of times of clicking a certain piece of information on a web page to the number of times of displaying the piece of information.
2) Duration: referring to a consumption duration of information by a user, such as a duration of reading information by the user.
3) Interaction: including but not limited to operations such as giving a like, sharing, adding to favorites, reposting and following for information by a user.
4) Ranking: scoring recalled candidate information, and selecting a plurality of pieces of information ranked among the top from the recalled candidate information according to scores in a sequence from high to low as a recommendation result.
5) Embedding: a function for mapping in a perspective of mathematics, where original data are mapped or embedded into another numeric vector space through the function, a continuous vector is used for representing a discrete variable, and the reason it is called Embedding is that this representation method is usually accompanied by dimensionality reduction, like high-dimensional data are squeezed and embedded into a low-dimensional space.
6) Multiple layer perceptron (MLP): a feedforward artificial neural network model, mapping a plurality of inputted data sets onto a single outputted data set and being capable of processing a problem of non-linear separability.
7) Multi-gate mixture-of-experts (MMoE): a common network structure for multi-recommendation-target learning, which is composed of a plurality of expert networks and a plurality of gated networks, where most of the expert networks are DNN network structures, the expert networks are used for extracting different features from input data used for performing multi-recommendation-target learning, equivalently, information included in the input data is divided into a plurality of regions, each region corresponds to an expert network, each expert network extracts features in different dimensions from the input data, the gated networks are used for allocating a weight of each expert network, there may be the plurality of gated networks for a plurality of tasks, a description is made by taking a task A as an example, the gated network corresponding to the task A outputs a probability that each expert network is selected, the output probability of being selected is used as a wight of the corresponding expert network, and thus weighted summation processing may be performed on the features outputted by the plurality of expert networks to obtain a comprehensive feature corresponding to the task A.
8) Personalized feature: predicting a demand and a preference of a user according to previous click data and interaction data of the user as well as click data and interaction data of a similar user, and the like so as to recommend the user an item that the user possibly likes.
9) Self-adaption: automatically adjusting a processing method and a parameter weight according to a data feature of processed data and being a process that a mathematical model keeps approaching a target.
10) Multi-recommendation-target fusion: learning to obtain estimated scores of a plurality of targets, where all the estimated scores are added or multiplied according to strategies such as significance and a business indicator demand of each target.

In a recommendation system, a multi-recommendation-target ranking model is usually used for estimating scores (namely, recommendation scores) of a plurality of recommendation targets (namely, recommendation dimensions), and in the related art, the plurality of scores are difficult to fuse into a comprehensive score for ranking, and besides, an optimal effect is difficult to realize in business.

In the related art, a formula fusion method is adopted to fuse the plurality of scores into the comprehensive score for ranking, specifically, a prediction model of each target is trained independently, then predicted scores of the different targets are fused through a formula and then fused through adding, multiplying or a more complicated formula, parameters may be used in a fusion process, in order to find relatively good parameters, different parameter groups further need to be searched off line, and common methods include a grid-search or a heuristic method (such as a genetic algorithm and a particle swarm algorithm).

The above modes at least have the following defects: if the prediction models of the plurality of targets are trained independently, this mode costs highly, the plurality of prediction models cannot share parameters and thus cannot be trained jointly, feature learning cannot be accelerated either, moreover, online service load pressure is high, the number of loaded prediction models is large, the calculation amount is relatively large, resource consumption is large, and stability is poor; and if added new target data are sparse, effective model training and iteration are difficult to perform. Clearly, such method depends too much on a manual rule despite independent training of the plurality of prediction models or joint training of a multi-recommendation-target network, an offline and online data distribution difference exists, an offline parameter search verifying effect depends on collection of online data and specifying of an effect indicator, and significance of the plurality of targets is difficult to quantify; parameter tuning needs to traverse many groups of parameter combinations, which consumes time and efforts, is difficult to adapt to real-time change of business data, costs highly and lacks personality and contextualization; and when there are a growing number of targets, formula ranking capability is limited, an optimal parameter combination cannot be found, and consequently a business indicator becomes poor possibly. Therefore, the above methods are not suitable for full users and do not consider a personalization level difference of the users, and as each user has different inclinations to different targets, realization of the optimal effect on all the users by the models is limited.

Therefore, embodiments of this application provide a method and apparatus for information recommendation, an electronic device, a computer readable storage medium and a computer program product, which can accurately predict a recommendation score of a user for information so as to improve recommendation accuracy and user experience of a recommendation system.

A method for information recommendation provided by an embodiment of this application may be implemented by various electronic devices, for example, may be implemented by a terminal alone, or may also be implemented by a server alone, or may also be implemented by the terminal and the server collaboratively. For example, the terminal alone executes the method for information recommendation described below, or the terminal transmits a recommendation request to the server, and the server executes the method for information recommendation according to the received recommendation request.

An electronic device for information recommendation provided by an embodiment of this application may be various types of terminal devices or servers. The servers may be standalone physical servers, or may also be a server cluster composed of a plurality of physical servers or a distributed system, or may also be cloud servers providing a cloud computing service. The terminal may be a smartphone, a tablet computer, a notebook computer, a desktop computer, a smart speaker, a smartwatch, a vehicle-mounted terminal or the like, but is not limited thereto. The terminal and the server may be connected directly or indirectly in a wired or wireless communication mode, which is not limited here in this embodiment of this application.

The server, taken as an example, may be, for example, a server cluster deployed on cloud to open AI as a Service (AIaaS) to a user, an AIaaS platform may split several categories of common AI services and provide a standalone service or a packaged service on cloud, such service mode is similar to an AI theme mall, and all users may access and use one or more artificial intelligence services provided by the AIaaS platform through an application programming interface.

For example, one artificial intelligence cloud service may be an information recommendation service, that is, the server on cloud is packaged with an information recommendation program provided by an embodiment of this application. The user calls the information recommendation service in the cloud service through a terminal (running a client, such as an instant messaging client, a livestreaming client, a short video client and a social client) so as to make the server deployed on cloud call the packaged information recommendation program, determine a recommendation score of a target object for to-be-recommended information and execute a recommendation operation of the to-be-recommended information corresponding to the target object based on the recommendation score.

In some embodiments, description is made by taking an example that the server alone implements the method for information recommendation provided by this embodiment of this application. The server performs encoding processing on a plurality of reference features respectively to obtain an encoding feature of each reference feature, where the reference features include at least one of the following: an object feature of a target object or an information feature of to-be-recommended information; performs first mapping processing on the plurality of encoding features to obtain a plurality of first recommendation scores which are in one-to-one correspondence with a plurality of recommendation dimensions, the first recommendation scores representing recommendation scores of the target object for the to-be-recommended information in the corresponding recommendation dimensions; executes the following processing for each recommendation dimension: performing second mapping processing on the plurality of encoding features in the recommendation dimension to obtain a mapping feature of the recommendation dimension; performs fusion processing on the first recommendation scores of the plurality of recommendation dimensions based on the mapping feature of each recommendation dimension to obtain a fusion feature, and performs recommendation score prediction processing on the to-be-recommended information based on the fusion feature to obtain a second recommendation score of the target object for the to-be-recommended information; and executes a recommendation operation of the to-be-recommended information corresponding to the target object based on the second recommendation score of the to-be-recommended information.

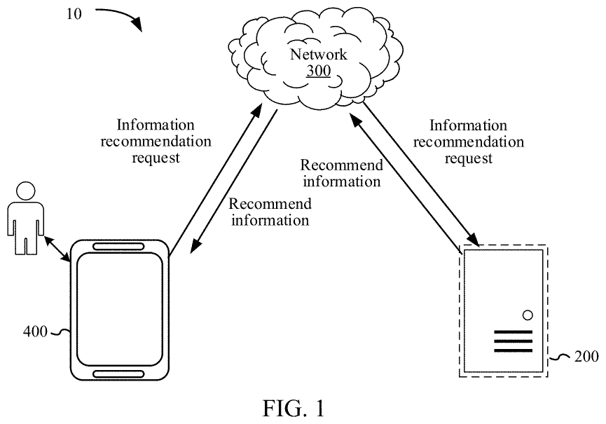

In some embodiments, description is made by taking an example that the server and the terminal collaboratively implement the method for information recommendation provided by this embodiment of this application. Referring to FIG. 1, FIG. 1 is a schematic architectural diagram of an information recommendation system 10 provided by an embodiment of this application. A terminal 400 is connected with a server 200 through a network 300, and the network 300 may be a wide area network or a local area network, or a combination of both. The terminal 400 (running a client, such as an instant messaging client, a livestreaming client, a short video client and a social client) may be adopted to obtain an information recommendation request of a user. Taking the user of the terminal 400 being a target object as an example, for example, after the target object opens a news client run on the terminal, the terminal automatically obtains a news recommendation request for the target object.

In some embodiments, the terminal, after obtaining the information recommendation request, calls an information recommendation interface (may be provided as a form of cloud service, namely, an information recommendation service) of the server 200, and the server 200 obtains a plurality of reference features of the target object based on the information recommendation request, where the target object is a certain user needing to be recommended information, and the reference features include at least one of the following: an object feature (namely, a user feature, such as a user age, a user gender and other data) of the target object or an information feature of to-be-recommended information; and recalls to-be-recommended information suitable for the above reference features from a to-be-recommended information base as candidate information for ranking.

It may be understood that in this embodiment of this application, when this embodiment of this application is applied to a specific product or a technology, involved related data such as the user feature need to be permitted or consented by the user, and collection, use and processing of the related data need to conform to related laws and regulations and standards in a related country or region.

In a ranking stage, encoding processing is performed on the plurality of reference features to obtain an encoding feature of each reference feature, where the reference features include at least one of the following: the object feature of the target object, or the information feature of the recalled to-be-recommended information; first mapping processing is performed on the plurality of encoding features to obtain a plurality of first recommendation scores which are in one-to-one correspondence with a plurality of recommendation dimensions; the following processing is executed for each recommendation dimension: performing second mapping processing on the plurality of encoding features in the recommendation dimension to obtain a mapping feature of the recommendation dimension; fusion processing is performed on the first recommendation scores of the plurality of recommendation dimensions based on the mapping feature of each recommendation dimension to obtain a fusion feature, and recommendation score prediction processing is performed on the to-be-recommended information based on the fusion feature to obtain a second recommendation score of the target object for the to-be-recommended information; and the recalled to-be-recommended information is reranked based on the second recommendation score of the to-be-recommended information, and a plurality of pieces of to-be-recommended information ranked among the top (namely, a plurality of pieces of to-be-recommended information starting from the first one) are selected and pushed to the terminal 400 for displaying.

The target object involved in this embodiment of this application is a receiver of information recommended by the information recommendation system, for example, when the target object opens the news client, the target object is a received of news recommended by a news recommendation system, and the involved object feature of the target object in this embodiment of this application is obtained with permission of the target object.

In some embodiments, the method for information recommendation provided by this embodiment of this application may also be applied to an information recommendation scenario related to an Internet of vehicles service (such as refueling, navigation, parking and maintenance), for example, when information recommendation is performed on a vehicle-mounted terminal, the method for information recommendation provided by this embodiment of this application is executed for the target object of the vehicle-mounted terminal, a final recommendation score of the target object for the to-be-recommended information is determined, and a recommendation operation of the to-be-recommended information corresponding to the target object is executed based on the final recommendation score. For example, a corresponding shielding mode is applied to to-be-recommended information with a final recommendation score being lower than a score threshold, and to-be-recommended information with a final recommendation score exceeding the score threshold is recommended to the vehicle-mounted terminal, so that wide propagation of information with low quality is avoided, overall information quality is improved indirectly, and the user experience is improved.

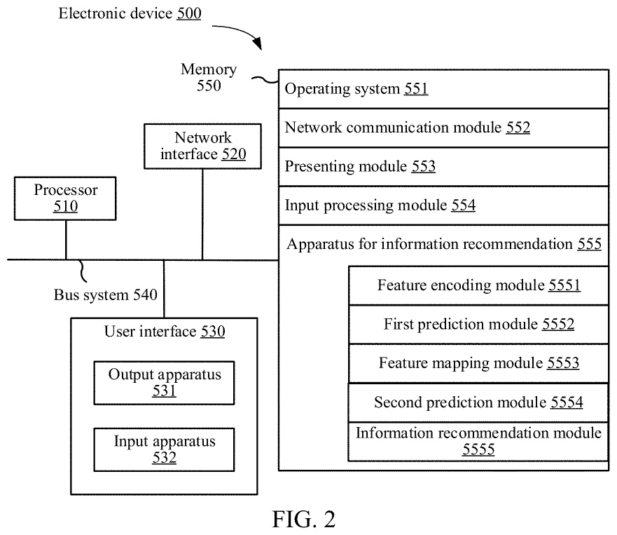

A structure of an electronic device for information recommendation provided by an embodiment of this application is described below. Referring to FIG. 2, FIG. 2 is a schematic structural diagram of an electronic device 500 for information recommendation provided by an embodiment of this application. Description is made by taking the electronic device 500 being a server as an example, and the electronic device 500 for information recommendation shown in FIG. 2 includes: at least one processor 510, a memory 550, at least one network interface 520 and a user interface 530. All components in the electronic device 500 are coupled together by a bus system 540. It may be understood that, the bus system 540 is configured to achieve connection and communication between these components. In addition to a data bus, the bus system 540 further includes a power bus, a control bus, and a state signal bus. But, for ease of clear description, various buses in FIG. 2 are marked as the bus system 540.

The processor 510 may be an integrated circuit chip and has signal processing capability, for example, a general-purpose processor, a digital signal processor (DSP), other programmable logic devices, discrete gate or transistor logic devices, a discrete hardware assembly, or the like. The general-purpose processor may be a microprocessor, any conventional processor, or the like.

The memory 550 includes a volatile memory or a non-volatile memory, or may include both the volatile memory and the non-volatile memory. The non-volatile memory may be a read only memory (ROM), and the volatile memory may be a random access memory (RAM). The memory 550 described in this embodiment of this application is intended to include any suitable type of memory. The memory 550 includes one or more storage devices away from the processor 510 physically.

In some embodiments, the memory 550 can store data to support various operations, and examples of these data include a program, a module and a data structure or a subset or superset thereof, which is described exemplarily below.

An operating system 551 includes system programs for processing various basic system services and executing hardware-related tasks, such as a frame layer, a core library layer, and a drive layer, used for achieving various basic businesses and processing hardware-based tasks.

A network communication module 552 is configured to reach other electronic devices via one or more (wired or wireless) network interfaces 520. An exemplary network interface 520 includes: Bluetooth, wireless fidelity (WiFi), a universal serial bus (USB) and the like.

A presentation module 553 is configured to present information (for example, a user interface configured to operate a peripheral device and display content and information) via one or more output apparatuses 531 (such as a display screen and a speaker) associated with the user interface 530.

An input processing module 554 is configured to detect one or more user inputs or interactions from one of one or more input apparatuses 532 and translate the detected input(s) or interaction(s).

In some embodiments, an apparatus for information recommendation provided by an embodiment of this application may be implemented in a form of software, for example, may be the information recommendation service in the server described above, or may also be an information recommendation plug-in in the terminal described above. Certainly, without being limited to this, the apparatus for information recommendation provided by this embodiment of this application may be provided as various software embodiments, including various forms such as an application program, software, a software module, a script or a code.

In some embodiments, the apparatus for information recommendation provided by this embodiment of this application may be implemented in a form of software. FIG. 2 shows the apparatus 555 for information recommendation stored in the memory 550. The apparatus may be software in a form of a program, a plug-in and the like and includes the following software modules: a feature encoding module 5551, a first prediction module 5552, a feature mapping module 5553, a second prediction module 5554 and an information recommendation module 5555. These modules are logic and may therefore be combined at will or further split according to functions implemented by them. The function of each module will be described below.

The method for information recommendation provided by this embodiment of this application will be described below with reference to the accompanying drawings. An executive body of the following method for information recommendation may be a server, and specifically, the method may be implemented by running various computer programs above by the server. Certainly, it is easily seen according to understanding of the following that the method for information recommendation provided by this embodiment of this application may also be implemented collaboratively by the terminal and the server.

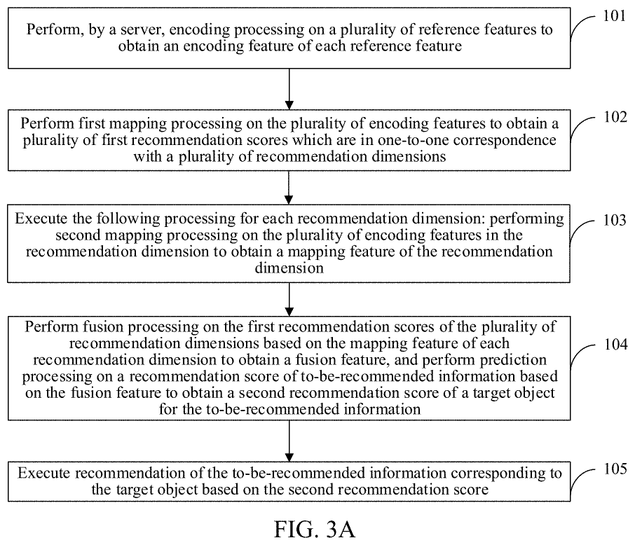

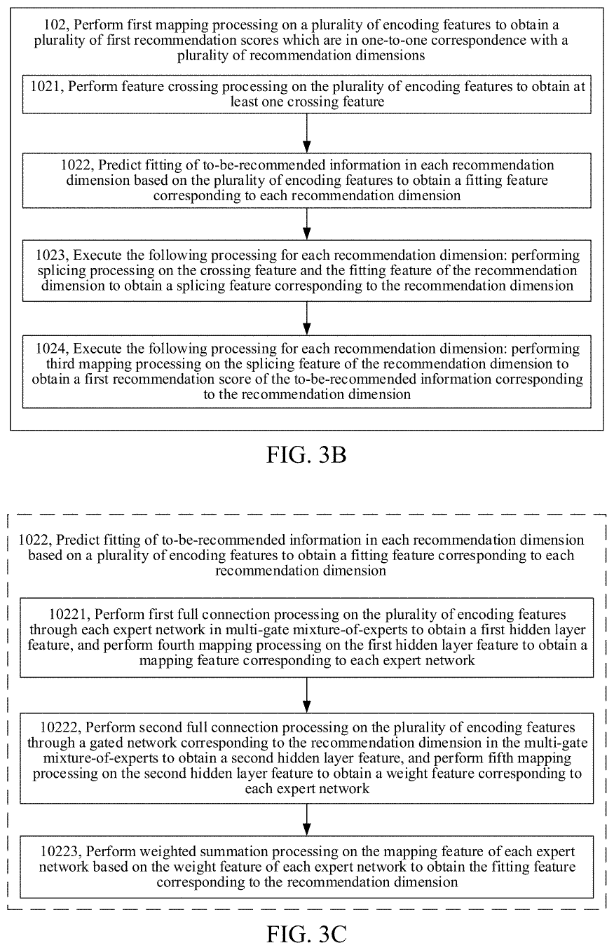

Referring to FIG. 3A, which is a schematic flowchart of a method for information recommendation provided by an embodiment of this application, description will be made with reference to steps shown in FIG. 3A.

In step 101, the server performs encoding processing on a plurality of reference features to obtain an encoding feature of each reference feature.

The reference features include at least one of the following: an object feature of a target object or an information feature of to-be-recommended information. The object feature is a basic attribute feature (such as an age, a gender, an occupation, a level of education, a consumption level) and a portrait feature (such as hobbies and interests, browsing, click, adding to favorites, purchasing and other behavior data) of the target object, and a feature of a context where recommendation is located (an environment feature, such as recommendation time and a recommendation scenario), the information feature is an information tag, an information category, an information source and an interaction feature of the to-be-recommended information, the interaction feature is a feature with an information content being related to the object feature, the interaction feature is specifically an intersection of the information feature and the object feature, for example, consumption conditions of users in different ages and genders for the to-be-recommended information are statistically calculated to obtain a consumption feature of another user in the same age and gender as the user for the to-be-recommended information, and the consumption feature is the interaction feature between the to-be-recommended information and the user.

It may be understood that in this embodiment of this application, when this embodiment of this application is applied to a specific product or technology, involved related data such as the basic attribute feature and the portrait feature need to be permitted or consented by the user, and collection, use and processing of the related data need to conform to related laws and regulations and standards in a related country and region.

During actual implementation, any one feature may be selected therefrom as the reference feature, or a plurality of features may be selected therefrom to be freely combined as the reference features, that is, a scale dimensionality of the reference feature is settable, for example, all or part of the object features of the target object are used as the reference features, or all or part of the information features of the to-be-recommended information are used as the reference features, or all the object features of the target object and all the information features of the to-be-recommended information are used as the reference features, or part of the object features of the target object and all the information features of the to-be-recommended information are used as the reference features, or part of the object features of the target object and part of the information features of the to-be-recommended information are used as the reference features, or the like.

In some embodiments, the reference features include at least one of a continuous feature and a discrete feature. Step 101 may be implemented in the following mode: executing the following processing for each reference feature: performing, when the reference features are the continuous features, discretization processing on the continuous features to obtain discrete features of the continuous features, and performing encoding processing on the discrete features of the continuous features to obtain encoding features of the continuous features; and performing, when the reference features are the discrete features, encoding processing on the discrete features to obtain encoding features of the discrete features, where different forms of features may be encoded unitedly through this embodiment of this application, which is equivalent to being mapped into the same encoding space, so that subsequent data processing may be performed based on a unified reference feature, and data processing efficiency and accuracy are improved.

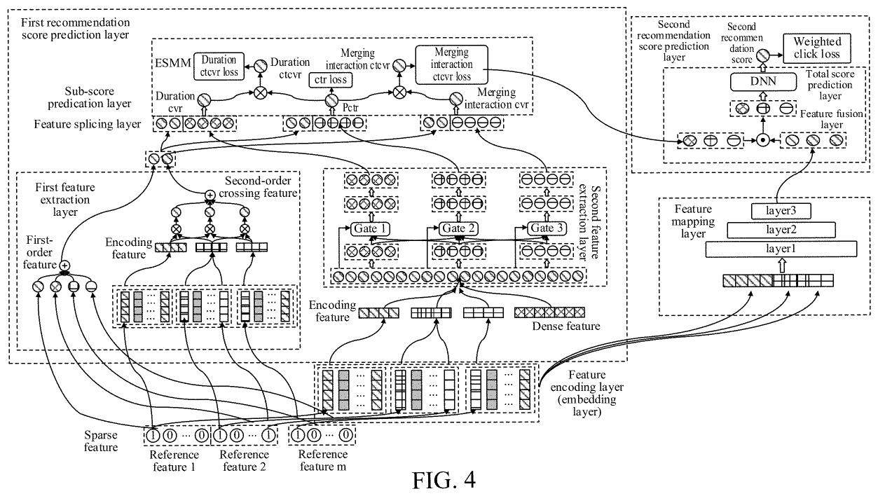

As an example, a data form of the continuous features is continuous data and may be any value within an interval, for example, both a video duration and a release actual effect belong to the continuous features, a data form of the discrete features is discrete data and usually represented in a form of an integer, for example, a user age and a user gender, discrete data 0 is used for representing that the user gender is male, and discrete data 1 is used for representing that the user gender is female. There are many types of discretization modes for the continuous features, for example, a mode of a Chi-Squared test is adopted, for example, a mode of a decision-making tree is adopted for discretization, and a mode of interval division may also be adopted for discretization. As an example, encoding processes of the different reference features are different. Referring to FIG. 4, which is a schematic diagram of information recommendation provided by an embodiment of this application, description is made by taking the to-be-recommended information being a video as an example, the continuous features in the reference features may be a video duration, a release actual effect and the like, the discrete features may be a video identifier, a user account grade, a user gender and the like, and targeted encoding processing needs to be performed on the different features. For example, discretization is performed on the continuous features such as the video duration and the release actual effect, or normalization or standardization processing is performed on the continuous features to obtain the discrete features (namely, a discrete numerical value, also called a sparse feature) of the continuous features, and then encoding processing is performed on the discrete features of the continuous features, for example, the discrete features are mapped into another vector space to obtain the encoding features (Embedding, also called a dense feature) of the continuous features. Encoding processing is performed directly on the discrete features such as the video identifier, the user account grade and the user gender, for example, the discrete features are mapped into another vector space to obtain the encoding features (Embedding, also called the dense feature) of the discrete features.

In step 102, first mapping processing is performed on the plurality of encoding features to obtain a plurality of first recommendation scores which are in one-to-one correspondence with a plurality of recommendation dimensions.

In some embodiments, referring to FIG. 3B, which is a schematic diagram of determining of a first recommendation score provided by an embodiment of this application, step 102 may be implemented through step 1021 to step 1024 shown in FIG. 3B.

In step 1021, feature crossing processing is performed on the plurality of encoding features to obtain at least one crossing feature.

In some embodiments, before executing step 1021, linear processing is performed on the plurality of reference features to obtain a first-order feature, and then the server may perform feature crossing processing on the plurality of encoding features in the following mode to obtain at least one crossing feature: performing second-order feature crossing processing on any two encoding features in the plurality of encoding features to obtain a second-order crossing feature of any two encoding features; and performing splicing processing on the first-order feature and each second-order crossing feature to obtain the at least one crossing feature. The crossing feature may have memorability through this embodiment of this application, non-linear capability of subsequent data processing may be improved, and thus the recommendation accuracy is improved.

As shown in FIG. 4, linear computation is performed on the plurality of reference features, for example, weighted summation processing is performed on the plurality of reference features based on a weight of each reference feature to obtain the first-order feature. Second-order feature crossing processing is performed on any two encoding features to obtain the second-order crossing feature of any two encoding features. Description is made by taking the reference feature being the object feature as an example, for the encoding feature xᵢᵤ=[xᵢᵤ₁, xᵢᵤ₂, . . . , xᵢᵤₙ] of the object feature, xᵢᵤ represents the object feature of a user i, m is the number of the object features, xᵢᵤ₁ represents the first object feature of the user i, the second-order crossing feature of any two encoding features is p_{i,j}=<xᵢᵤₐ, x_{iub}>, a=1, . . . , m, b=1, . . . , m, splicing processing is performed on all second-order crossing features p=Σ(p_{i,j}) of any two encoding features and the first-order feature of the reference feature to obtain low-order crossing features with memorability, the number of the crossing features is the same as the number of the second-order crossing features, and a low-order feature refers to a feature with an order being lower than a set threshold.

In some embodiments, a crossing feature of any specified order may also be obtained, for example, i-order crossing processing is performed on any i (2≤i≤m, m is the number of the reference features) encoding features in the encoding features corresponding to the plurality of reference features respectively to obtain an i-order crossing feature of any i encoding features, and splicing processing is performed on the first-order feature and the i-order crossing feature to obtain the crossing feature, so that high-order information may be considered during subsequent prediction of the first recommendation scores, and the recommendation accuracy is improved.

In some embodiments, in order to improve a processing speed, splicing processing may also be performed on the first-order feature and the i-order crossing feature to obtain a splicing feature, then matrix decomposition processing is performed on the obtained splicing feature, for example, when i=2, after obtaining the splicing feature by performing splicing on all second-order crossing features of any two encoding features and the first-order feature of the reference feature, matrix decomposition processing is performed on the obtained splicing feature to obtain a decomposition feature, and non-linear mapping processing is performed on the decomposition feature through an activation function to obtain the corresponding crossing feature.

Crossing information among the different encoding features is captured by performing feature crossing processing on each encoding feature in the above mode to enhance representing capability of the encoding features and avoid omitting a feature boundary so as to perform subsequent prediction processing based on an accurate crossing feature.

In step 1022, fitting of the to-be-recommended information in each recommendation dimension is predicted based on the plurality of encoding features to obtain a fitting feature corresponding to each recommendation dimension.

The fitting feature is a feature used for representing a fitting freedom degree between any two recommendation dimensions in all the recommendation dimensions, the fitting feature is usually a high-order feature, the high-order feature is a feature with an order being greater than the set threshold, and the recommendation dimension refers to an indicator used for assessing the recommendation system, for example, the recommendation dimension includes a click through rate, the number of times of interactions, a viewing duration and the like.

In some embodiments, referring to FIG. 3C, which is a schematic diagram of determining of a fitting feature provided by an embodiment of this application, step 1022 may be implemented by executing step 10221 to step 10223 shown in FIG. 3C for each recommendation dimension. In step 10221, first full connection processing is performed on the plurality of encoding features through each expert network in multi-gate mixture-of-experts to obtain a first hidden layer feature, and fourth mapping processing is performed on the first hidden layer feature to obtain a mapping feature corresponding to each expert network. In step 10222, second full connection processing is performed on the plurality of encoding features through gated networks of the corresponding recommendation dimensions in the multi-gate mixture-of-experts to obtain a second hidden layer feature, and fifth mapping processing is performed on the second hidden layer feature to obtain a weight feature corresponding to each expert network. In step 10223, weighted summation processing is performed on the mapping feature of each expert network based on the weight feature of each expert network to obtain a fitting feature of the corresponding recommendation dimension. Tasks for the plurality of recommendation dimensions are learned at the same time through this embodiment of this application, so that these tasks achieve the better effect than that of independently training tasks of one recommendation dimension, and an overfitting phenomenon in a data processing process may be relieved.

The multi-gate mixture-of-experts is composed of a plurality of expert networks and a plurality of gated networks, the expert networks are used for extracting different mapping feature, a structure of each expert network may be a full connection neural network structure, the gated networks are used for outputting the weight feature allocated to each expert network, each gated network is equivalent to one classifier, the gated network of each recommendation dimension judges which expert networks are better for fitting according to the currently inputted encoding features, and thus the weight feature of each expert network is estimated. The number of the gated networks is consistent with the number of the recommendation dimensions, the number of the expert networks may be consistent or inconsistent with the number of the recommendation dimensions, that is, each recommendation dimension corresponds to one gated network, for example, when the recommendation dimensions are three dimensions of the click through rate, the viewing duration and the number of times of interactions, the recommendation dimension of “click through rate” corresponds to the gated network 1, the recommendation dimension of “viewing duration” corresponds to the gated network 2, and the recommendation dimension of “the number of times of interactions” corresponds to the gated network 3.

As shown in FIG. 4, the encoding features corresponding to the plurality of reference features are inputted into each expert network, firstly, first full connection processing is performed on the plurality of encoding features through the expert networks corresponding to all the recommendation dimensions to obtain the corresponding first hidden layer feature, and linear or non-linear mapping processing is performed on the first hidden layer feature through the activation function to obtain the mapping feature corresponding to each expert network. Then, the plurality of encoding features and the mapping features outputted by the plurality of expert networks are inputted into the gated networks, second full connection processing, such as multilayer perceptual processing, is performed on the plurality of encoding features through the gated networks to obtain the second hidden layer feature, then linear or non-linear mapping processing is performed on the second hidden layer feature through the activation function to obtain the weight feature corresponding to each expert network, weighted summation processing is performed on the mapping feature outputted by each expert network by means of the weight feature to obtain the fitting features (outputs of the gated networks) corresponding to the recommendation dimensions (the recommendation dimensions corresponding to the gated networks), and the output of the gated network corresponding to each recommendation dimension is used as an output of the whole multi-gate mixture-of-experts.

In step 1023, the following processing is executed for each recommendation dimension: performing splicing processing on the crossing features and the fitting features of the recommendation dimensions to obtain the splicing features corresponding to the recommendation dimensions.

Here, after splicing the low-order crossing features with memorability and high-order features corresponding to all the recommendation dimensions, subsequent score prediction is performed based on the splicing features, score prediction accuracy may be improved, and thus the recommendation accuracy is improved.

As shown in FIG. 4, after obtaining the fitting feature outputted by the gated network corresponding to each recommendation dimension, splicing processing is performed on the crossing features and the fitting feature corresponding to each recommendation dimension respectively to obtain the splicing feature corresponding to each recommendation dimension. Still taking the three recommendation dimensions of the click through rate, the viewing duration and the number of times of interactions as an example, splicing is performed on the above obtained crossing features and the fitting feature of the recommendation dimension of “click through rate” to obtain the splicing feature of the recommendation dimension of “click through rate”; splicing is performed on the above obtained crossing features and the fitting feature of the recommendation dimension of “viewing duration” to obtain the splicing feature of the recommendation dimension of “viewing duration”; and splicing is performed on the above obtained crossing features and the fitting feature of the recommendation dimension of “the number of times of interactions” to obtain the splicing feature of the recommendation dimension of “the number of times of interactions”.

In step 1024, the following processing is executed for each recommendation dimension: performing third mapping processing on the splicing feature of the recommendation dimension to obtain a first recommendation score of the to-be-recommended information corresponding to the recommendation dimension.

In some embodiments, for each recommendation dimension, the third mapping processing is performed on the corresponding splicing feature to obtain the mapping feature corresponding to the splicing feature, and offset processing is performed on the mapping feature of the splicing feature through the activation function to obtain the first recommendation score corresponding to each recommendation dimension, the first recommendation score representing a recommendation score of the target object for the to-be-recommended information in the corresponding recommendation dimension.

In some embodiments, for each recommendation dimension, linear logistic regression processing is performed on the splicing feature through a logistic regression function, the linear logistic regression processing here may be linear addition processing, an obtained linear addition result is used as a projection feature, or the linear addition result may also be substituted into the logistic regression function to obtain a logistic regression feature as the projection feature, and then recommendation score prediction processing is performed on the projection feature through the activation function to obtain the first recommendation scores for representing high and low recommendation scores.

Still taking the above example, after obtaining the splicing features corresponding to the three recommendation dimensions of the click through rate, the viewing duration and the number of times of interactions respectively, a first recommendation score of the recommendation dimension of “click through rate”, a first recommendation score of the recommendation dimension of “viewing duration” and a first recommendation score of the recommendation dimension of “the number of times of interactions” are predicted.

In step 103, the following processing is executed for each recommendation dimension: performing second mapping processing on the plurality of encoding features in the recommendation dimension to obtain the mapping feature of the recommendation dimension.

In some embodiments, step 103 may be implemented in the following mode: performing horizontal splicing processing on the first recommendation scores of the plurality of recommendation dimensions to obtain a tiling vector; performing third full connection processing on the plurality of encoding features to obtain a third hidden layer feature; and performing sixth mapping processing on the third hidden layer feature to obtain a mapping feature with the same dimension as the tiling vector.

Here, during actual implementation, after obtaining the first recommendation score corresponding to each recommendation dimension, horizontal splicing processing is performed on a vector representation of each first recommendation score to obtain a tiling vector corresponding to the first recommendation score, which is marked as xᵢᵤ=[xᵢᵤ₁, xᵢᵤ₂, . . . , xᵢᵤₙ], where xᵢₙ represents a vector representation of the first recommendation score of an n^{th} recommendation dimension, and n represents the number of the recommendation dimensions; and then, the plurality of encoding features are subjected to dimensionality reduction into a mapping feature with the same dimensionality scale as the tiling vector, for example, the plurality of encoding features are subjected to third full connection processing to obtain the corresponding third hidden layer feature, non-linear mapping processing (sixth mapping processing) is performed on the hidden layer feature through the activation function to obtain the mapping feature with the same dimensionality scale as the tiling vector, and thus subsequent correlation calculation of the mapping feature and the first recommendation score of each recommendation dimension is facilitated.

In step 104, fusion processing is performed on the first recommendation scores of the plurality of recommendation dimensions based on the mapping feature of each recommendation dimension to obtain a fusion feature, and recommendation score prediction processing is performed on the to-be-recommended information based on the fusion feature to obtain the second recommendation score of the target object for the to-be-recommended information.

In some embodiments, performing fusion processing on the first recommendation scores of the plurality of recommendation dimensions based on the mapping feature of each recommendation dimension to obtain the fusion feature in step 104 is equivalent to that the mapping feature of each recommendation dimension is used as a weight of the first recommendation score of each recommendation dimension, and weighted summation processing may be performed on the first recommendation scores of the plurality of recommendation dimensions based on the weight of the first recommendation score of each recommendation dimension, which may be implemented specifically in the following mode: obtaining a score matrix composed of the first recommendation score of each recommendation dimension, and obtaining a mapping matrix composed of the mapping feature corresponding to each recommendation dimension; and performing element-wise product calculation on the score matrix and the mapping matrix to obtain the fusion feature.

The score matrix is the tiling vector xᵢₙ obtained by performing horizontal splicing processing on the vector representation of each first recommendation score described above, the mapping matrix is the mapping feature with the same dimensionality scale as the tiling vector and is marked as wᵢᵤ, and the fusion feature obtained by performing element-wise product calculation on the score matrix and the mapping matrix is marked as: w_{i,um}=wᵢᵤ ●xᵢₘ, representing that matrix point multiplication is performed on the score matrix and the mapping matrix of the plurality of recommendation dimensions so as to measure inclination degrees of the target object in the different recommendation dimensions.

In some embodiments, performing recommendation score prediction processing on the to-be-recommended information based on the fusion feature to obtain the second recommendation score of the target object for the to-be-recommended information in step 104 may be implemented in the following mode: performing seventh mapping processing on the fusion feature to obtain the mapping feature corresponding to the fusion feature; and performing recommendation score prediction processing on the to-be-recommended information based on the mapping feature corresponding to the fusion feature to obtain the second recommendation score of the target object for the to-be-recommended information.

During recommendation score prediction, mapping processing is performed on the fusion feature, for example, linear projection is performed on the fusion feature through the logistic regression function, and then an obtained projection value passes through the activation function to obtain the second recommendation score of the target object for the to-be-recommended information by prediction.

In step 105, the recommendation operation of the to-be-recommended information corresponding to the target object is executed based on the second recommendation score.

The second recommendation score is a final score obtained by synthesizing the plurality of recommendation dimensions and is used for representing whole assessment of the target object for the to-be-recommended information, and when the second recommendation score exceeds the score threshold, the to-be-recommended information is recommended to the target object.

In some embodiments, the method for information recommendation provided by this embodiment of this application may be suitable for a recall stage of a recommendation system.

A structure of the recommendation system is introduced below. The recommendation system includes the recall stage, a coarse ranking stage, a fine ranking stage and a reranking stage. The recall stage is: selecting each piece of candidate information from a candidate pool for scoring in a subsequent ranking stage, where the candidate pool is a candidate information pool for recommendation. The coarse ranking stage is: ranking thousands or hundreds of pieces of candidate information selected by recall. The fine ranking stage is: accurately ranking coarse ranking results. The reranking stage is: making slight adjustment to a fine ranking result.

After obtaining a second recommendation score of each piece of recalled candidate information, the recalled candidate information is ranked according to the second recommendation scores in a sequence from high to low, and a plurality of pieces of candidate information ranked among the top (namely, a plurality of pieces of candidate information starting from the first one) are selected and pushed to a terminal for displaying.

In some embodiments, an assessment grade of the target object for the to-be-recommended information may also be determined according to the second recommendation scores, and thus different recommendation operations are performed according to the assessment grade. For example, when the assessment grade includes a first grade, a second grade and a third grade which are sequentially increased (the user being more and more interested), and the assessment grade for the to-be-recommended information is the first grade, weight-reduced recommendation is performed on the to-be-recommended information in the ranking stage of the recommendation system, so as to reduce the number of times of recommendations or a recommendation frequency, for example, before weight-reduced ranking is adopted, the information may be possibly recommended to 100 persons within one week, after the weight-reduced ranking is adopted, the information may be possibly recommended to only 20 persons within one week, besides, a weight-reduced amplitude is in a negative correlation relationship with a final core of the to-be-recommended information, that is, the lower the final core of the to-be-recommended information is, the larger the weight-reduced amplitude is, and the lower the number of times of recommendations or the recommendation frequency for the information within a certain time after the weight-reduced ranking is. In the recall stage of the recommendation system, in a recall result containing the to-be-recommended information, the to-be-recommended information is subjected to temporary filtering or permanent filtering, then coarse ranking processing, fine ranking processing and reranking processing are performed on filtered information (information obtained through recall), finally, recommendation is performed based on a reranking result, and thus information of no interest to the user is prevented from being recommended to the target object or other users similar to the target object.

When the assessment grade for the to-be-recommended information is the second grade, the to-be-recommended information is freely recommended, and free recommendation is not to perform bias recommendation on the to-be-recommended information, neither weighted recommendation nor weight-reduced recommendation, and is to perform recommendation based on a user demand and the quality of the information itself. When the assessment grade for the to-be-recommended information is the third grade, weighted recommendation is performed on the to-be-recommended information, so that the to-be-recommended information of interest to the target object may be recommended to more other users similar to the target object, and an exposure rate and the click through rate of the to-be-recommended information are increased.

In some embodiments, the above method for information recommendation is implemented by calling a score prediction model. As shown in FIG. 4, the score prediction model includes: a feature encoding layer, a first recommendation score prediction layer, a feature mapping layer and a second recommendation score prediction layer. The first recommendation score prediction layer includes a first feature extraction layer, a second feature extraction layer, a feature splicing layer and a sub-score prediction layer. The second recommendation score prediction layer includes a feature fusion layer and a total score prediction layer.

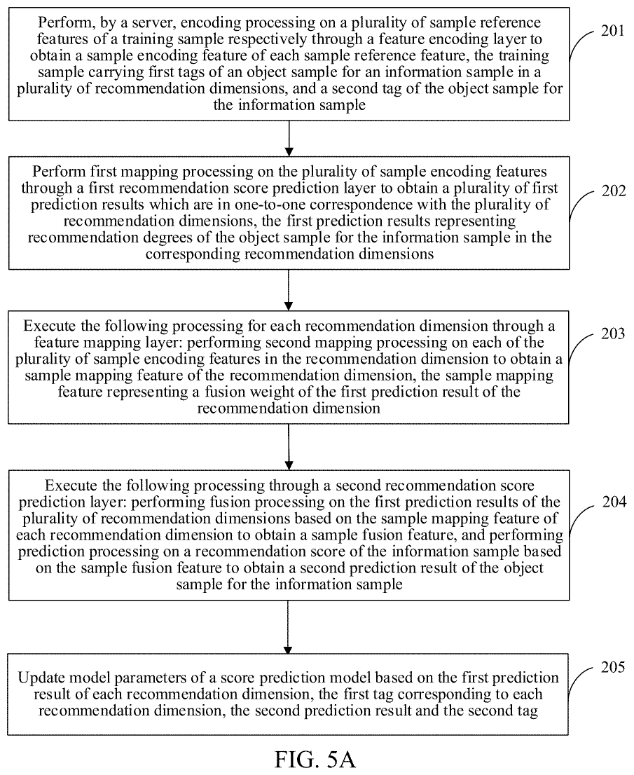

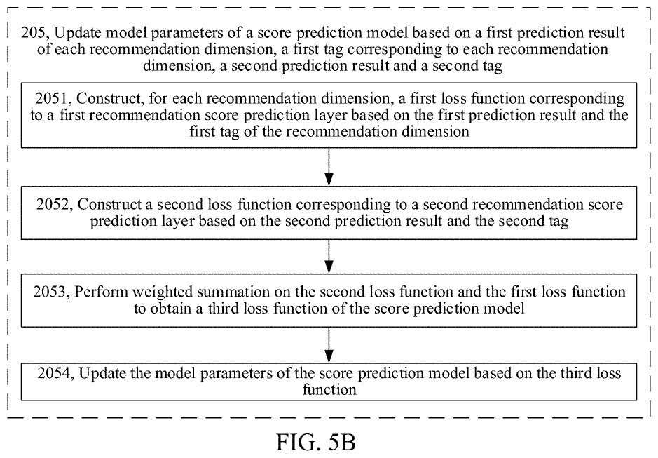

In some embodiments, referring to FIG. 5A, which is a schematic flowchart of a model training method provided by an embodiment of this application, the score prediction model may be trained in the following mode: in step 201, a server performs encoding processing on a plurality of sample reference features of a training sample respectively through the feature encoding layer to obtain a sample encoding feature of each sample reference feature, the training sampling carrying a first tag of an object sample for an information sample in a plurality of recommendation dimensions, and a second tag of the object sample for the information sample. In step 202, first mapping processing is performed on the plurality of sample encoding features through the first recommendation score prediction layer to obtain a plurality of first prediction results which are in one-to-one correspondence with the plurality of recommendation dimensions, the first prediction results representing recommendation scores of the object sample for the information sample in the corresponding recommendation dimensions. In step 203, the following processing is executed for each recommendation dimension through the feature mapping layer: performing second mapping processing on each of the plurality of encoding features in the recommendation dimension to obtain a sample mapping feature of the recommendation dimension. In step 204, the following processing is executed through the second recommendation score prediction layer: performing fusion processing on the first prediction results of the plurality of recommendation dimensions based on the sample mapping feature of each recommendation dimension to obtain a sample fusion feature, and performing recommendation score prediction processing on the information sample based on the sample fusion feature to obtain a second prediction result of the object sample for the information sample. In step 205, model parameters of the score prediction model are updated based on the first prediction result of each recommendation dimension, the first tag corresponding to each recommendation dimension, the second prediction result and the second tag.

During actual implementation, the training sample is inputted into the score prediction model, firstly, encoding processing is performed on the plurality of sample reference features of the training sample through the feature encoding layer, and a sparse feature of the plurality of reference features is transformed to a dense feature. Secondly, feature crossing processing is performed on the plurality of sample encoding features of the training sample through the first feature extraction layer in the first recommendation score prediction layer to obtain a sample crossing feature; fitting of the to-be-recommended information in at least two recommendation dimensions is predicted based on the plurality of sample encoding features through the second feature extraction layer to obtain a sample fitting feature corresponding to each recommendation dimension; splicing processing is performed on the sample crossing feature and the sample fitting feature corresponding to each recommendation dimension respectively through the feature splicing layer to obtain a sample splicing feature corresponding to each recommendation dimension; and the recommendation scores for the to-be-recommended information in at least two recommendation dimensions are predicted based on the sample splicing feature through the sub-score prediction layer to obtain the first prediction results of the object sample for the information sample in the at least two recommendation dimensions. Thirdly, second mapping processing is performed on the plurality of encoding features of the training sample in each recommendation dimension through the feature mapping layer to obtain the sample mapping feature. Finally, fusion processing is performed on the first prediction results of the object sample for the information sample in the at least two recommendation dimensions based on the sample mapping feature of each recommendation dimension through the feature fusion layer in the second score prediction layer to obtain the corresponding sample fusion feature; and recommendation score prediction processing is performed on the to-be-recommended information based on the sample fusion feature through the total score prediction layer to obtain the second prediction result of the object sample for the to-be-recommended information.

As an example, encoding processes of the different sample reference features are different, when the sample reference feature is a continuous feature, encoding processing is performed on a discrete feature of the continuous feature, for example, the discrete feature is mapped into another vector space to obtain the encoding feature (Embedding, also called the dense feature) of the continuous feature; and when the sample reference feature is the discrete feature, encoding processing is directly performed on the discrete feature such as a video identifier, a user account grade and a user gender, for example, the discrete feature is mapped into another vector space to obtain the encoding feature (Embedding, also called the dense feature) of the discrete feature.

In some embodiments, referring to FIG. 5B, which is a schematic flowchart of a model parameter updating method provided by an embodiment of this application, step 205 may be implemented through step 2051 to step 2054 shown in FIG. 5B. In step 2051, for each recommendation dimension, a first loss function corresponding to the first recommendation score prediction layer is constructed based on the first prediction results and the first tag of the recommendation dimension. In step 2052, a second loss function corresponding to the second recommendation score prediction layer is constructed based on the second prediction result and the second tag. In step 2053, weighted summation is performed on the second loss function and the first loss function to obtain a third loss function of the score prediction model. In step 2054, model parameters of the score prediction model are updated based on the third loss function.

In some embodiments, above step 2051 may be implemented in the following mode: constructing a loss subfunction corresponding to each recommendation dimension based on the first prediction result corresponding to each recommendation dimension and the corresponding first tag; and determining a recommendation weight corresponding to each recommendation dimension, and performing weighted summation on the loss subfunction corresponding to each recommendation dimension based on each recommendation weight to obtain the first loss function corresponding to the first recommendation score prediction layer.

Here, as for each recommendation dimension, after obtaining the corresponding first prediction results, the corresponding loss subfunction may be constructed based on the first prediction results and the first tag of the object sample for the information sample in the corresponding recommendation dimension, the loss subfunctions of the plurality of recommendation dimensions are added to obtain the first loss function

$${L}_{1} = {\sum }_{j = 1}^{n} {loss}_{j}$$

of the first recommendation score prediction layer, where n represents the number of the recommendation dimensions, lossⱼ represents the loss subfunction corresponding to a j^{th} recommendation dimension, and 1≤1≤n.

After obtaining the final second prediction result by synthesizing all the recommendation dimensions, the second loss function L(θ) of the second recommendation score prediction layer may be constructed based on the second prediction result and the second tag of the object sample for the information sample, which is represented as:

$$L ( θ ) = {\sum }_{i = 1}^{n} - {a}_{i} [ {y}_{i} log p ( {w}_{i , um} \vert θ ) + ( 1 - {y}_{i} ) log ( 1 - p ( {w}_{i , um} \vert θ ) ) ] ;$$

where

p(w_{i,um}|θ)=σ(ƒ(w_{i,um}|θ)), σ(108) is a sigmoid function, ƒ(w′w_{i,um}|θ) is the second prediction result, the second prediction result is transformed into an estimated probability p(w_{i,um}|θ), n is the total number of training samples, θ is the model parameters, yᵢ is the second tag, aₗ is different weights set according to the recommendation dimensions, for example, one training sample has two recommendation dimensions of click and interaction, aᵢ may be set to be 2 and is greater than a weight (smaller than 2) of a training sample only having one recommendation dimension of click, and the model is more inclined to learn the training sample with the interaction dimension.

The whole third loss function of the score prediction model is obtained by adding the first loss function (namely, a sum of the independent loss subfunctions of each recommendation dimension in the plurality of recommendation dimensions) and the second loss function and is represented as:

$$Loss = {L}_{1} + L ( θ ) = {\sum }_{j = 1}^{n} {loss}_{j} + L ( θ ) .$$

After constructing the third loss function, whether a value of the third loss function exceeds a preset threshold is judged according to the value of the third loss function, when the value of the third loss function exceeds the preset threshold, an error signal of the score prediction model is determined based on the third loss function, error information is backpropagated in the score prediction model, and model parameters of each layer are updated in a propagation process.

Here, backpropagation is described, the reference features of the training samples are inputted into an input layer of a neural network model, pass through a hidden layer and finally reach an output layer to output a result, and this is a forward propagation process of the neural network model. As an output result of the neural network model has an error compared with an actual result, the error between the output result and an actual value is calculated, the error is backpropagated from the output layer to the hidden layer till being propagated to the input layer, and in the backpropagation process, values of the model parameters are adjusted according to the error; and the above process is repeatedly iterated till convergence, where the score prediction model belongs to the neural network model.

An exemplary application of this embodiment of this application in an actual application scenario will be described below. The method for information recommendation provided by this embodiment of this application may be applied to all recommendation systems using a multi-recommendation-target ranking model, for example, may be applied to client recommendation, a browser information stream scenario, news, bulletin recommendation and other information stream products, or may also be applied to other recommendation scenarios such as the field of e-commerce and advertisement recommendation scenarios. Taking multi-recommendation-target score fusion of the three recommendation dimensions of click, duration and interaction as an example below, the method for information recommendation provided by this embodiment of this application is described.

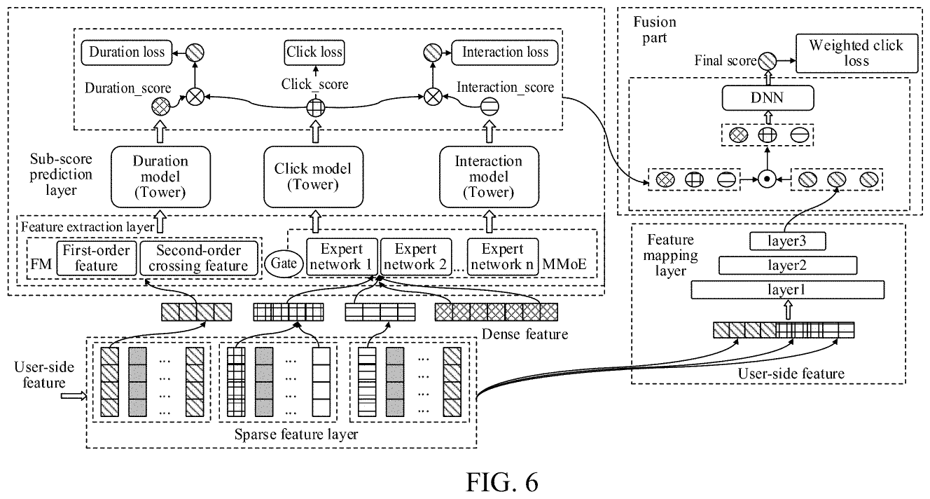

Referring to FIG. 6, which is a schematic diagram of information recommendation provided by an embodiment of this application, information recommendation is performed through the multi-recommendation-target ranking model, and the model includes: a sparse feature layer, a feature extraction layer, a sub-score prediction layer, a feature mapping layer and a fusion part. Training and application of the score prediction model will be described below with reference to FIG. 6.

1. Sparse Feature Layer

When selected, user-side features (namely, the above reference features) of the training samples may be selected from user features (namely, the above object features) of the object sample and the information features of the to-be-recommended information. The user features are the basic attribute features (such as the age, the gender, the occupation, the level of education and the consumption level) and the portrait features (such as the hobbies and interests, browsing, click, adding to favorites, purchasing and other behavior data) of the target object, and the feature of context where recommendation is located (the environment feature, such as the recommendation time and the recommendation scenario), the information features are an information tag, an information category, an information source and an information content of the information sample and an interaction feature with the user features, the interaction feature refers to an intersection of the information features and the user features, for example, consumption conditions of users in different ages and genders for the to-be-recommended information are statistically calculated to obtain a consumption feature of a user in the user age and gender for the to-be-recommended information through a detailed age and gender of the user, and the consumption feature is the interaction feature between the to-be-recommended information and the user.

When the continuous feature exists in the user-side features, discretization processing needs to be performed on the continuous feature firstly, or normalization or standardization processing is performed on the continuous feature to obtain the discrete feature. In general, the discrete feature is the sparse feature, encoding processing needs to be performed on the discrete feature through the sparse feature layer, for example, vector transformation processing is performed through Embedding to obtain the corresponding encoding feature (also called the dense feature). Splicing is performed on the obtained encoding feature and the user-side features, namely, the dense features, of a user side to obtain a user-side feature vector (namely, the encoding feature) which is xᵢᵤ=[xᵢᵤ₁, xᵢᵤ₂, . . . , xᵢᵤₙ], where m is the number of the user-side features.

2. Feature Extraction Layer

The feature extraction layer includes a crossing feature extraction layer and a fitting feature extraction layer, where the crossing feature extraction layer may be a factorization machine (FM) model, the fitting feature extraction layer may be an MMoE model, second-order feature crossing is performed on all the encoding features of the user-side features through the crossing feature extraction layer to obtain corresponding second-order crossing features, and first-order features and second-order crossing features of all the encoding features are spliced to obtain low-order crossing features with memorability; and the MMoE model is composed of the plurality of expert networks and the plurality of gated networks, the expert networks are used for extracting different features and may be a DNN network structure, the gated networks are used for allocating a weight of each expert network, each gated network is equivalent to one classifier, the gated network of each recommendation dimension judges which expert networks are better for fitting according to the currently inputted encoding features, and thus the weight of each expert network is estimated. Finally, the low-order crossing features with memorability and a high-order feature corresponding to each target and outputted by the MMoE model are spliced, and then inputted into the sub-score prediction layer for score prediction.

3. Sub-Score Prediction Layer

The sub-score prediction layer includes three models for score prediction of click, duration and interaction, the three models are independent from one another, and the crossing features and an output corresponding to each target and outputted by the MMoE model are spliced and then inputted into the corresponding models for score prediction to obtain the corresponding scores (namely, the above first recommendation scores).

4. Feature Mapping Layer

After obtaining the score corresponding to each target, horizontal splicing processing is performed on a vector representation of each score to obtain a multi-recommendation-target score vector, marked as xᵢₘ=[xᵢ₁, xᵢ₂, . . . , xᵢₙ] where xᵢₙ represents a vector representation of a score of an n^{th} target, and n represents the number of the targets; then, through the feature mapping layer, the encoding features of the user-side features are subjected to dimensionality reduction into a matrix with the same dimensionality scale as the multi-recommendation-target score vector, marked as wᵢᵤ, where the feature mapping layer may be an MLP network, such as a DNN network; and afterwards, the fusion feature obtained by performing element-wise product calculation on the multi-recommendation-target score vector and the matrix of the user-side features after dimensionality reduction is marked as: w_{i,um}=wᵢᵤ □xᵢₘ, so as to measure inclination degrees of the target object in different targets.

The feature mapping layer is actually a lightweight network of a user, the features inputted into the feature mapping layer may come from the encoding features outputted by the sparse feature layer, namely, the features inputted into the feature mapping layer may be part of or all the encoding features outputted by the sparse feature layer, or may also be other new features, for example, user-side features different from the user-side features inputted into the sparse feature layer are obtained, the newly obtained user-side features may even include information features, and the newly obtained user-side features are subjected to encoding processing and then inputted into the feature mapping layer.

In the above mode, an optimal fusion mode of all target scores may be given according to different users by means of introduction of user personalized features, equivalently, a final score is given automatically according to inclinations of the users on the different targets, and a relatively better effect is achieved in business performance.

5. Fusion Part

The fusion part plays a role in predicting the final score of the target object for the to-be-recommended information, and during actual implementation, the final score (namely, the above second recommendation score) of the target object for the to-be-recommended information is obtained by prediction through a DNN according to the above fusion feature w_{i,um}=wᵢᵤ□xᵢₘ: final_{score}=ƒ(w_{i,m}|θ)

6. Loss Function

Here, after obtaining the score corresponding to each target, the corresponding loss subfunctions may be constructed based on the scores and the tags, carried by the training samples, of the object sample for the information sample in the corresponding targets, and the loss subfunctions of all the targets are added to obtain the loss function

$${L}_{1} = {\sum }_{j = 1}^{n} {loss}_{j}$$

of the sub-score prediction layer, where n represents the number of the targets, and lossⱼ represents the loss subfunction corresponding to a j^{th} target, 1≤j≤n.

After obtaining the final score, the loss function L(θ) of the fusion part may be constructed based on the final score and the tags, carried by the training samples, of the object sample for the information sample and is represented as:

$$L ( θ ) = {\sum }_{i = 1}^{n} - {a}_{i} [ {y}_{i} log p ( {w}_{i , um} \vert θ ) + ( 1 - {y}_{i} ) log ( 1 - p ( {w}_{i , um} \vert θ ) ) ] ;$$

where

p(w_{i,um}|θ)=σ(ƒ(w_{i,um}|θ)) is the sigmoid function, ƒ(w_{i,um}|θ), is the final score, the final score is transformed to the estimated probability p(w_{i,um}|θ), n is the total number of the training samples, yᵢ is the tag, aᵢ is the different weights set for the targets, for example, one training sample has two targets of click and interaction, aᵢ may be set to be 2 and is greater than a weight (smaller than 2) of a training sample having only one target of click, and the model is more inclined to learn a training sample with interaction.

The whole loss function of the multi-recommendation-target ranking model is a sum of the loss function of the sub-score prediction layer and the loss function of the fusion part and is represented as:

$$Loss = {L}_{1} + L ( θ ) = {\sum }_{j = 1}^{n} {loss}_{j} + L ( θ ) .$$

After constructing the whole loss function of the multi-recommendation-target ranking model, whether a value (e.g., a gradient value) of the whole loss function of the multi-recommendation-target ranking model exceeds a preset threshold is judged, when the value exceeds the preset threshold, the error signal of the model is determined based on the whole loss function of the multi-recommendation-target ranking model, the error signal is backpropagated in the score prediction model, and model parameters of the various layers are updated in a propagation process.

Clearly, the multi-recommendation-target ranking model provided by this embodiment of this application is an end-to-end model, the influence of data distribution in an offline scenario and an online scenario do not need to be considered, joint training of the loss function of the fusion part and the other loss functions of the multi-recommendation-target is performed, only one model needs to be loaded for online prediction use, and convenience and stability of service deployment are improved.

8. Prediction Stage

Taking the to-be-recommended information being an article as an example, when a user makes a request, the user-side features (including the user features, the information features of candidate articles, the crossing features, the context feature and the like) are inputted into the multi-recommendation-target ranking model to obtain an estimated click through rate, an estimated duration or a duration probability of a current user for each candidate article, which are transformed into scores to form the multi-recommendation-target score vector xᵢₘ, meanwhile, the feature mapping layer is constructed according to the needed user-side features, passes through the MLP and then outputs wᵢᵤ, xᵢₘ and wᵢᵤ are subjected to point multiplication to obtain a point multiplication result w_{i,um}=wᵢᵤ □xᵢₘ, finally, w_{i,um} is inputted into the fusion part to obtain the final score final_{score}=ƒƒ(w_{i,um}|θ) of the user for the candidate article, all the candidate articles are ranked according to the final scores in a sequence from large to small, and top K articles are returned as a result to be presented to the user.

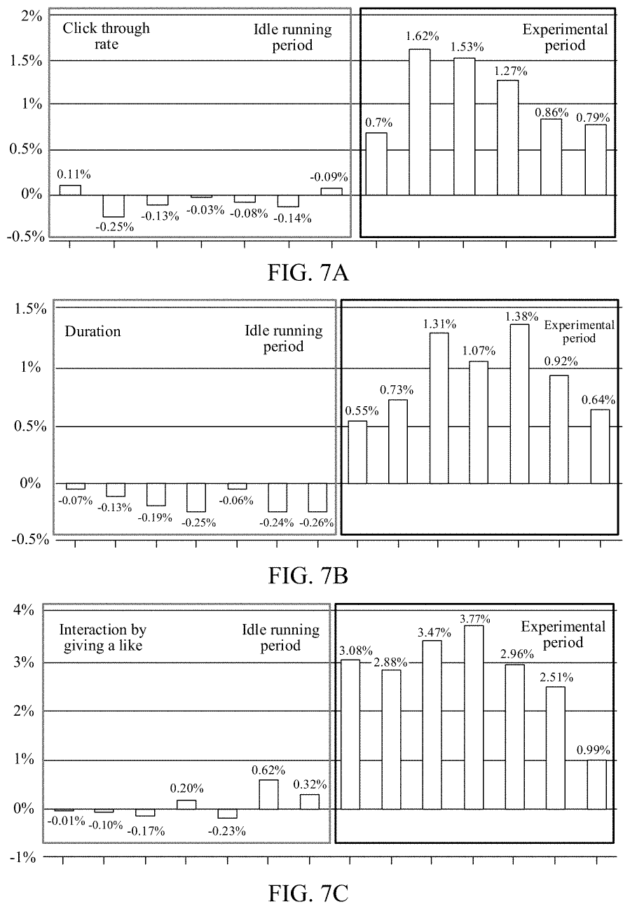

Referring to FIG. 7A to FIG. 7C, which are schematic diagrams of an information recommendation effect provided by an embodiment of this application, taking an example that the method for information recommendation provided by this embodiment of this application is applied to an image-text focus recommendation scenario, compared with general formula fusion and grid-search methods, by using the method for information recommendation provided by this embodiment of this application, in terms of relative increasing amplitudes of the three targets such as the click through rate, a total reading duration and the number of persons giving a like, for example, the click through rate is relatively increased by 1.16% on average and relatively increased by 1.62% at most (FIG. 7A), the duration is relatively increased by 1.17% on average and relatively increased by 1.38% at most (FIG. 7B), and giving a like is relatively increased by 2.76% on average and relatively increased by 3.77% at most (FIG. 7C), where the general formula fusion and the grid-search methods are used in an idle running period, and an experimental period is a relative increasing effect of the method for information recommendation provided by this embodiment of this application compared with the general fusion and the grid-search methods.

In this way, this embodiment of this application provides an end-to-end multi-recommendation-target score fusion model based on user personalized features and aims to solve a problem of fusing the scores of a multi-recommendation-target model for the different targets into one score for ranking, the method for information recommendation provided by this embodiment of this application introduces the MLP network to self-adaptively learn multi-recommendation-target fusion scoring on the basis of MMoE-based multi-recommendation-target model, that is, by introducing the user-side features, personalization weights from each user to the different target scores may be learned self-adaptively, the user-side features are synthesized to obtain an optimal fusion score, thus optimization of each target is achieved, without dependence on a manual formula and parameter search, and time and efforts are saved.

An exemplary structure of an apparatus 555 for information recommendation being implemented as a software module provided by an embodiment of this application continues to be described below. In some embodiments, the software module in the apparatus 555 for information recommendation stored in a memory 550 in FIG. 2 may include: a feature encoding module 5551, configured to perform encoding processing on a plurality of reference features of a target object respectively to obtain an encoding feature of each reference feature; a first prediction module 5552, configured to perform first mapping processing on the plurality of encoding features to obtain a plurality of first recommendation scores which are in one-to-one correspondence with a plurality of recommendation dimensions, the first recommendation scores representing recommendation scores of the target object for to-be-recommended information in the corresponding recommendation dimensions; a feature mapping module 5553, configured to execute the following processing for each recommendation dimension: performing second mapping processing on the plurality of encoding features in the recommendation dimension to obtain a mapping feature of the recommendation dimension; a second prediction module 5554, configured to perform fusion processing on the first recommendation scores of the plurality of recommendation dimensions based on the mapping feature of each recommendation dimension to obtain a fusion feature, and perform recommendation score prediction processing on the to-be-recommended information based on the fusion feature to obtain a second recommendation score of the target object for the to-be-recommended information; and an information recommendation module 5555, configured to execute a recommendation operation of the to-be-recommended information corresponding to the target object based on the second recommendation score.

In some embodiments, the reference features include at least one of a continuous feature and a discrete feature. The feature encoding module 5551 is further configured to execute the following processing for each reference feature: performing, when the reference features are the continuous features, discretization processing on the continuous features to obtain discrete features of the continuous features, and performing encoding processing on the discrete features of the continuous features to obtain encoding features of the continuous features; and performing, when the reference features are the discrete features, encoding processing on the discrete features to obtain encoding features of the discrete features.

In some embodiments, the first prediction module 5552 is further configured to perform feature crossing processing on the plurality of encoding features to obtain at least one crossing feature; predict fitting of the to-be-recommended information in each recommendation dimension based on the plurality of encoding features to obtain a fitting feature corresponding to each recommendation dimension; execute the following processing for each recommendation dimension: performing splicing processing on the crossing feature and the fitting feature of the recommendation dimension to obtain a splicing feature corresponding to the recommendation dimension; and execute the following processing for each recommendation dimension: performing third mapping processing on the splicing feature of the recommendation dimension to obtain the first recommendation score of the to-be-recommended information corresponding to the recommendation dimension.

In some embodiments, the first prediction module 5552 is further configured to perform linear processing on the plurality of reference features to obtain a first-order feature; perform second-order feature crossing processing on any two encoding features in the plurality of encoding features to obtain a second-order crossing feature of any two encoding features; and perform splicing processing on the first-order feature and the second-order crossing feature to obtain at least one crossing feature.

In some embodiments, the first prediction module 5552 is further configured to execute the following processing for each recommendation dimension: performing first full connection processing on the plurality of encoding features through each expert network in multi-gate mixture-of-experts to obtain a first hidden layer feature, and performing fourth mapping processing on the first hidden layer feature to obtain a mapping feature corresponding to each expert network; performing second full connection processing on the plurality of encoding features through a gated network corresponding to the recommendation dimension in the multi-gate mixture-of-experts to obtain a second hidden layer feature, and performing fifth mapping processing on the second hidden layer feature to obtain a weight feature corresponding to each expert network; and performing weighted summation processing on the mapping feature of each expert network based on the weight feature of each expert network to obtain the fitting feature corresponding to the recommendation dimension.

In some embodiments, the feature mapping module 5553 is further configured to perform horizontal splicing processing on the first recommendation scores of the plurality of recommendation dimensions to obtain a tiling vector; perform third full connection processing on the plurality of encoding features to obtain a third hidden layer feature; and perform sixth mapping processing on the third hidden layer feature to obtain a mapping feature with the same dimension as the tiling vector.

In some embodiments, the second prediction module 5554 is further configured to obtain a score matrix composed of the first recommendation score of each recommendation dimension and obtain a mapping matrix composed of the mapping feature corresponding to each recommendation dimension; and perform element-wise product calculation on the score matrix and the mapping matrix to obtain the fusion feature.

In some embodiments, the second prediction module 5554 is further configured to perform seventh mapping processing on the fusion feature to obtain the mapping feature corresponding to the fusion feature; and perform recommendation score prediction processing on the to-be-recommended information based on the mapping feature corresponding to the fusion feature to obtain the second recommendation score of the target object for the to-be-recommended information.

In some embodiments, the apparatus for information recommendation is implemented by calling a score prediction model. The score prediction model includes: a feature encoding layer, a first recommendation score prediction layer, a feature mapping layer and a second recommendation score prediction layer. The apparatus further includes: a model training module, configured to perform encoding processing on a plurality of sample reference features of a training sample respectively through the feature encoding layer to obtain a sample encoding feature of each sample reference feature, the training sample carrying first tags of an object sample for an information sample in the plurality of recommendation dimensions, and a second tag of the object sample for the information sample; perform first mapping processing on the plurality of sample encoding features through the first recommendation score prediction layer to obtain a plurality of first prediction results which are in one-to-one correspondence with the plurality of recommendation dimensions, the first prediction results representing recommendation scores of the object sample for the information sample in the corresponding recommendation dimensions; execute the following processing for each recommendation dimension through the feature mapping layer: performing second mapping processing on each of the plurality of encoding features in the recommendation dimension to obtain a sample mapping feature of the recommendation dimension; execute the following processing through the second recommendation score prediction layer: performing fusion processing on the first prediction results of the plurality of recommendation dimensions based on the sample mapping feature of each recommendation dimension to obtain a sample fusion feature, and performing recommendation score prediction processing on the information sample based on the sample fusion feature to obtain a second prediction result of the object sample for the information sample; and update model parameters of the score prediction model based on the first prediction result of each recommendation dimension, the first tag corresponding to each recommendation dimension, the second prediction result and the second tag.

In some embodiments, the model training model is further configured to construct, for each recommendation dimension, a first loss function corresponding to the first recommendation score prediction layer based on the first prediction results and the first tag of the recommendation dimension; construct a second loss function corresponding to the second recommendation score prediction layer based on the second prediction result and the second tag; perform weighted summation on the second loss function and the first loss function to obtain a third loss function of the score prediction model; and update model parameters of the score prediction model based on the third loss function.

In some embodiments, the model training module is further configured to execute the following processing for each recommendation dimension: constructing a loss subfunction corresponding to the recommendation dimension based on the first prediction result corresponding to the recommendation dimension and the first tag of the recommendation dimension; and determining a recommendation weight corresponding to each recommendation dimension, and performing weighted summation on the loss subfunctions of the plurality of recommendation dimensions based on the recommendation weight corresponding to each recommendation dimension to obtain the first loss function corresponding to the first recommendation score prediction layer.

An embodiment of this application provides a computer program product or a computer program, the computer program product or the computer program including a computer executable instruction, and the computer executable instruction being stored in a computer readable storage medium. A processor of an electronic device reads the computer executable instruction from the computer readable storage medium and executes the computer executable instruction so that the electronic device executes the above method for information recommendation of this embodiment of this application.

An embodiment of this application provides a computer readable storage medium storing a computer executable instruction, the computer executable instruction, when executed by a processor, executing the method for information recommendation provided by this embodiment of this application, for example, the method for information recommendation shown in FIG. 3A.

In some embodiments, the computer readable storage medium may be a memory such as an FRAM, a ROM, a PROM, an EPROM, an EEPROM, a flash memory, a magnetic surface memory, a compact disc, or a CD-ROM. It may also be various devices including any one or a combination of the above memories.

In some embodiments, the executable instruction may adopt a form of a program, software, a software module, a script or a code, may be compiled in any form of programming language (including a compiling or interpretive language, or a declarative or procedural language), and may be deployed in any form, including being deployed as a standalone program or deployed as a module, a component, a subroutine or other units suitable for being used in a calculation scenario.

As an example, the executable instruction may be but not necessarily correspond to a file in a file system, and may be stored in part of a file storing other programs or data, for example, stored in one or more scripts in a hyper text markup language (HTML), stored in a single file special for a discussed program, or stored in a plurality of collaborative files (such as a file storing one or more modules, a subprogram or a code part).

As an example, the executable instruction may be deployed to be executed on one electronic device, or executed on a plurality of electronic devices located in one place, or executed on a plurality of electronic devices distributed in a plurality of places and interconnected through a communication network.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. The foregoing description is merely embodiments of this application and is not intended to limit the protection scope of this application. Any modification, equivalent replacement, improvement and the like made within the spirit and scope of this application shall fall within the protection scope of this application.

What is claimed is:

1. A method for information recommendation, executed by an electronic device and comprising:
performing encoding processing on a plurality of reference features to obtain an encoding feature of each reference feature, the reference features comprising at least one of the following: an object feature of a target object or an information feature of to-be-recommended information;
performing first mapping processing on the plurality of encoding features to obtain a plurality of first recommendation scores in one-to-one correspondence with a plurality of recommendation dimensions, the first recommendation scores representing recommendation scores of the target object for the to-be-recommended information in the corresponding recommendation dimensions;
performing second mapping processing on the plurality of encoding features in each of the plurality of recommendation dimensions to obtain a mapping feature of the recommendation dimension;
performing fusion processing on the first recommendation scores of the plurality of recommendation dimensions based on the mapping feature of each of the plurality of recommendation dimensions to obtain a fusion feature of the recommendation dimension, and performing recommendation score prediction processing on the to-be-recommended information based on the fusion feature to obtain a second recommendation score of the target object for the to-be-recommended information; and
executing a recommendation operation of the to-be-recommended information corresponding to the target object based on the second recommendation score of the to-be-recommended information.

2. The method according to claim 1, wherein the reference features comprise at least one of a continuous feature or a discrete feature, and the performing encoding processing on a plurality of reference features to obtain an encoding feature of each reference feature comprises:
performing, when the reference features are the continuous features, discretization processing on the continuous features to obtain discrete features of the continuous features, and performing encoding processing on the discrete features of the continuous features to obtain encoding features of the continuous features; and
performing, when the reference features are the discrete features, encoding processing on the discrete features to obtain encoding features of the discrete features.

3. The method according to claim 1, wherein the performing first mapping processing on the plurality of encoding features to obtain a plurality of first recommendation scores in one-to-one correspondence with a plurality of recommendation dimensions comprises:
performing feature crossing processing on the plurality of encoding features to obtain at least one crossing feature;
predicting fitting of the to-be-recommended information in each recommendation dimension based on the plurality of encoding features to obtain a fitting feature corresponding to each recommendation dimension;
performing splicing processing on the crossing feature and the fitting feature of each recommendation dimension to obtain a splicing feature corresponding to the recommendation dimension; and
performing third mapping processing on the splicing feature of each recommendation dimension to obtain the first recommendation score of the to-be-recommended information corresponding to the recommendation dimension.

4. The method according to claim 1, wherein the performing second mapping processing on the plurality of encoding features in each of the plurality of recommendation dimensions to obtain a mapping feature of the recommendation dimension comprises:
performing horizontal splicing processing on the first recommendation scores of the plurality of recommendation dimensions to obtain a tiling vector;
performing third full connection processing on the plurality of encoding features to obtain a third hidden layer feature; and
performing sixth mapping processing on the third hidden layer feature to obtain the mapping feature with the same dimension as the tiling vector.

5. The method according to claim 1, wherein the performing fusion processing on the first recommendation scores of the plurality of recommendation dimensions based on the mapping feature of each of the plurality of recommendation dimensions to obtain a fusion feature of the recommendation dimension comprises:
obtaining a score matrix composed of the first recommendation score of the recommendation dimension and obtaining a mapping matrix composed of the mapping feature corresponding to the recommendation dimension; and
performing element-wise product calculation on the score matrix and the mapping matrix to obtain the fusion feature.

6. The method according to claim 1, wherein the performing recommendation score prediction processing on the to-be-recommended information based on the fusion feature to obtain a second recommendation score of the target object for the to-be-recommended information comprises:
performing seventh mapping processing on the fusion feature to obtain a mapping feature corresponding to the fusion feature; and
performing recommendation score prediction processing on the to-be-recommended information based on the mapping feature corresponding to the fusion feature to obtain the second recommendation score of the target object for the to-be-recommended information.

7. An electronic device, comprising:
a memory, configured to store a computer executable instruction; and
a processor, configured to implement, when executing the computer executable instruction stored in the memory, a method for information recommendation including:
performing encoding processing on a plurality of reference features to obtain an encoding feature of each reference feature, the reference features comprising at least one of the following: an object feature of a target object or an information feature of to-be-recommended information;
performing first mapping processing on the plurality of encoding features to obtain a plurality of first recommendation scores in one-to-one correspondence with a plurality of recommendation dimensions, the first recommendation scores representing recommendation scores of the target object for the to-be-recommended information in the corresponding recommendation dimensions;
performing second mapping processing on the plurality of encoding features in each of the plurality of recommendation dimensions to obtain a mapping feature of the recommendation dimension;
performing fusion processing on the first recommendation scores of the plurality of recommendation dimensions based on the mapping feature of each of the plurality of recommendation dimensions to obtain a fusion feature of the recommendation dimension, and performing recommendation score prediction processing on the to-be-recommended information based on the fusion feature to obtain a second recommendation score of the target object for the to-be-recommended information; and
executing a recommendation operation of the to-be-recommended information corresponding to the target object based on the second recommendation score of the to-be-recommended information.

8. The electronic device according to claim 7, wherein the reference features comprise at least one of a continuous feature or a discrete feature, and the performing encoding processing on a plurality of reference features to obtain an encoding feature of each reference feature comprises:
performing, when the reference features are the continuous features, discretization processing on the continuous features to obtain discrete features of the continuous features, and performing encoding processing on the discrete features of the continuous features to obtain encoding features of the continuous features; and
performing, when the reference features are the discrete features, encoding processing on the discrete features to obtain encoding features of the discrete features.

9. The electronic device according to claim 7, wherein the performing first mapping processing on the plurality of encoding features to obtain a plurality of first recommendation scores in one-to-one correspondence with a plurality of recommendation dimensions comprises:
performing feature crossing processing on the plurality of encoding features to obtain at least one crossing feature;
predicting fitting of the to-be-recommended information in each recommendation dimension based on the plurality of encoding features to obtain a fitting feature corresponding to each recommendation dimension;
performing splicing processing on the crossing feature and the fitting feature of each recommendation dimension to obtain a splicing feature corresponding to the recommendation dimension; and
performing third mapping processing on the splicing feature of each recommendation dimension to obtain the first recommendation score of the to-be-recommended information corresponding to the recommendation dimension.

10. The electronic device according to claim 7, wherein the performing second mapping processing on the plurality of encoding features in each of the plurality of recommendation dimensions to obtain a mapping feature of the recommendation dimension comprises:
performing horizontal splicing processing on the first recommendation scores of the plurality of recommendation dimensions to obtain a tiling vector;
performing third full connection processing on the plurality of encoding features to obtain a third hidden layer feature; and
performing sixth mapping processing on the third hidden layer feature to obtain the mapping feature with the same dimension as the tiling vector.

11. The electronic device according to claim 7, wherein the performing fusion processing on the first recommendation scores of the plurality of recommendation dimensions based on the mapping feature of each of the plurality of recommendation dimensions to obtain a fusion feature of the recommendation dimension comprises:
obtaining a score matrix composed of the first recommendation score of the recommendation dimension and obtaining a mapping matrix composed of the mapping feature corresponding to the recommendation dimension; and
performing element-wise product calculation on the score matrix and the mapping matrix to obtain the fusion feature.

12. The electronic device according to claim 7, wherein the performing recommendation score prediction processing on the to-be-recommended information based on the fusion feature to obtain a second recommendation score of the target object for the to-be-recommended information comprises:
performing seventh mapping processing on the fusion feature to obtain a mapping feature corresponding to the fusion feature; and
performing recommendation score prediction processing on the to-be-recommended information based on the mapping feature corresponding to the fusion feature to obtain the second recommendation score of the target object for the to-be-recommended information.

13. A non-transitory computer readable storage medium, storing a computer executable instruction that, when executed by a processor of an electronic device, causes the electronic device to implement a method for information recommendation including:
performing encoding processing on a plurality of reference features to obtain an encoding feature of each reference feature, the reference features comprising at least one of the following: an object feature of a target object or an information feature of to-be-recommended information;
performing first mapping processing on the plurality of encoding features to obtain a plurality of first recommendation scores in one-to-one correspondence with a plurality of recommendation dimensions, the first recommendation scores representing recommendation scores of the target object for the to-be-recommended information in the corresponding recommendation dimensions;
performing second mapping processing on the plurality of encoding features in each of the plurality of recommendation dimensions to obtain a mapping feature of the recommendation dimension;
performing fusion processing on the first recommendation scores of the plurality of recommendation dimensions based on the mapping feature of each of the plurality of recommendation dimensions to obtain a fusion feature of the recommendation dimension, and performing recommendation score prediction processing on the to-be-recommended information based on the fusion feature to obtain a second recommendation score of the target object for the to-be-recommended information; and
executing a recommendation operation of the to-be-recommended information corresponding to the target object based on the second recommendation score of the to-be-recommended information.

14. The non-transitory computer readable storage medium according to claim 13, wherein the reference features comprise at least one of a continuous feature or a discrete feature, and the performing encoding processing on a plurality of reference features to obtain an encoding feature of each reference feature comprises:
performing, when the reference features are the continuous features, discretization processing on the continuous features to obtain discrete features of the continuous features, and performing encoding processing on the discrete features of the continuous features to obtain encoding features of the continuous features; and
performing, when the reference features are the discrete features, encoding processing on the discrete features to obtain encoding features of the discrete features.

15. The non-transitory computer readable storage medium according to claim 13, wherein the performing first mapping processing on the plurality of encoding features to obtain a plurality of first recommendation scores in one-to-one correspondence with a plurality of recommendation dimensions comprises:
performing feature crossing processing on the plurality of encoding features to obtain at least one crossing feature;
predicting fitting of the to-be-recommended information in each recommendation dimension based on the plurality of encoding features to obtain a fitting feature corresponding to each recommendation dimension;
performing splicing processing on the crossing feature and the fitting feature of each recommendation dimension to obtain a splicing feature corresponding to the recommendation dimension; and
performing third mapping processing on the splicing feature of each recommendation dimension to obtain the first recommendation score of the to-be-recommended information corresponding to the recommendation dimension.

16. The non-transitory computer readable storage medium according to claim 13, wherein the performing second mapping processing on the plurality of encoding features in each of the plurality of recommendation dimensions to obtain a mapping feature of the recommendation dimension comprises:
performing horizontal splicing processing on the first recommendation scores of the plurality of recommendation dimensions to obtain a tiling vector;
performing third full connection processing on the plurality of encoding features to obtain a third hidden layer feature; and
performing sixth mapping processing on the third hidden layer feature to obtain the mapping feature with the same dimension as the tiling vector.

17. The non-transitory computer readable storage medium according to claim 13, wherein the performing fusion processing on the first recommendation scores of the plurality of recommendation dimensions based on the mapping feature of each of the plurality of recommendation dimensions to obtain a fusion feature of the recommendation dimension comprises:
obtaining a score matrix composed of the first recommendation score of the recommendation dimension and obtaining a mapping matrix composed of the mapping feature corresponding to the recommendation dimension; and
performing element-wise product calculation on the score matrix and the mapping matrix to obtain the fusion feature.

18. The non-transitory computer readable storage medium according to claim 13, wherein the performing recommendation score prediction processing on the to-be-recommended information based on the fusion feature to obtain a second recommendation score of the target object for the to-be-recommended information comprises:
performing seventh mapping processing on the fusion feature to obtain a mapping feature corresponding to the fusion feature; and
performing recommendation score prediction processing on the to-be-recommended information based on the mapping feature corresponding to the fusion feature to obtain the second recommendation score of the target object for the to-be-recommended information.
